(19) United States
(12) Patent Application Publication
(10) Pub. No.: US 2005/0127083 A1
(43) Pub. Date: Jun. 16, 2005

(54) Gift wrap storage container

(76) Inventor: Stephan Edward Russell, Keswik (CA)

Correspondence Address: SAND & SEBOLT, AEGIS TOWER, SUITE 1100, 4940 MUNSON STREET, NW, CANTON, OH, 44718-3615, US

(21) Appl. No.: 10/981,333

(22) Filed: Nov. 4, 2004

Related U.S. Application Data
(60) Provisional application No. 60/517,346, filed on Nov. 4, 2003.

(51) Int. Cl. G07F 11/72

(52) U.S. Cl. 221/30

(57) ABSTRACT

A closeable storage case for holding sheet material such as gift wrapping paper and other related wrapping accessories. The storage case has at least one section that includes spaced apart roll retainers for rotatably mounting rolls of wrapping paper between them. The roll retainers include a support bracket and a roll engaging mechanism. The storage case includes a cutter mechanism for cutting sections of sheet material from the rolls held within the case and may also include compartments for securing adhesive tape and ribbon therein.

### CROSS-REFERENCE TO RELATED APPLICATIONS

This application is a non-provisional application claiming priority from U.S. provisional application No. 60/517,346 filed Nov. 4, 2003, the entire specification of which is incorporated herein by reference.

### BACKGROUND OF THE INVENTION

1. Technical Field

This invention generally relates to storage cases. More particularly, the invention relates to a closeable storage case for holding a number of rolls of sheet material such as gift wrapping paper. Specifically, the invention relates to a storage case that includes a plurality of coaxially aligned pairs of roll retaining mechanisms that secure rolls of paper between them but allow the rolls to rotate when paper is to be dispensed.

2. Background Information

One of the major problems with gift wrap is that the user ends up with multiple rolls of wrapping paper, with the tape and scissors being buried under the rolls and with trying to store the rolls of gift wrap in a manner that substantially prevents damage.

Therefore there is a need in the prior art to provide a case that holds a number of rolls of gift wrap and related implements and accessories and which can be easily and conveniently carried about and stored. It is also desirable to provide a case that allows any one of a number of rolls of gift wrap to be dispensed with rapidity and ease.

### SUMMARY OF THE INVENTION

The present invention is a storage case that has an upper section and a lower section that can be secured together to form a box with an interior. The box is adapted to securely hold a number of rolls of gift wrap so that they lie substantially parallel to the longitudinal axis of the box. The rolls are secured within the box so that they cannot be accidentally dislodged but at the same time they are secured in such a manner that the rolls can freely rotate as gift wrap is dispensed. The storage case also includes at least one compartment for securely holding other wrapping accessories, such as ribbon and adhesive tape. The case includes cutters for cutting sections of wrap, tape and ribbon from the rolls of the same which are secured within the interior of the box. The upper and lower sections of the case are securable together and the case includes a handle to allow it to be easily transported and stored.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of the storage case of the present invention shown in the closed position;

FIG. 2 is a perspective view of the storage case of FIG. 1, shown in the open position and illustrating a first embodiment of roll retainer for securing rolls of sheet material therein;

FIG. 3 is an exploded perspective view of the storage case of FIG. 2;

FIG. 3A is a cross-sectional front view of the storage case through line 3A-3A of FIG. 2;

FIG. 4 is an enlarged perspective view of the first embodiment of roll retainer for use in the storage case;

FIG. 5 is an enlarged perspective view of a second embodiment of roll retainer for use in the storage case;

FIG. 6 is a perspective view of the storage case incorporating a third embodiment of roll retainer therein;

FIG. 6A is an exploded perspective view of the storage case of FIG. 6;

FIG. 6B is a cross-sectional side view of the storage case of FIG. 6 in the closed position;

FIG. 6C is an enlarged perspective view of the roll retainer used in the storage case of FIG. 6; FIG. 7 is an exploded perspective view of the storage case showing a fourth embodiment of a roll retainer;

FIG. 7A is a cross-sectional front view of the storage case of FIG. 7 with the rolls secured therein;

FIG. 8 is a perspective view of a molded insert for the storage case and showing a fifth embodiment of roll retainer;

FIG. 8A is an enlarged partial perspective view of the left side of the roll retainer of FIG. 8 with the rolls of sheet material removed therefrom;

FIG. 8B is a rear perspective of the insert of FIG. 8;

FIG. 8C is an enlarged partial perspective view of a portion of the accessory compartment of the insert of FIG. 8;

FIG. 9 is a perspective view of a storage case in accordance with the present invention and incorporating a sixth embodiment of roll retainer therein;

FIG. 9A is an exploded perspective view of the storage case of FIG. 9;

FIG. 9B is a cross-sectional front view of the storage case of FIG. 9;

FIG. 9C is a cross-sectional side view of the storage case of FIG. 9 in the closed position;

FIG. 10 is a top view of a storage case in accordance with the present invention and showing a cutter mechanism mounted in the top wall thereof; and

FIG. 10A is a front view of the storage case of FIG. 10.

### DETAILED DESCRIPTION OF THE INVENTION

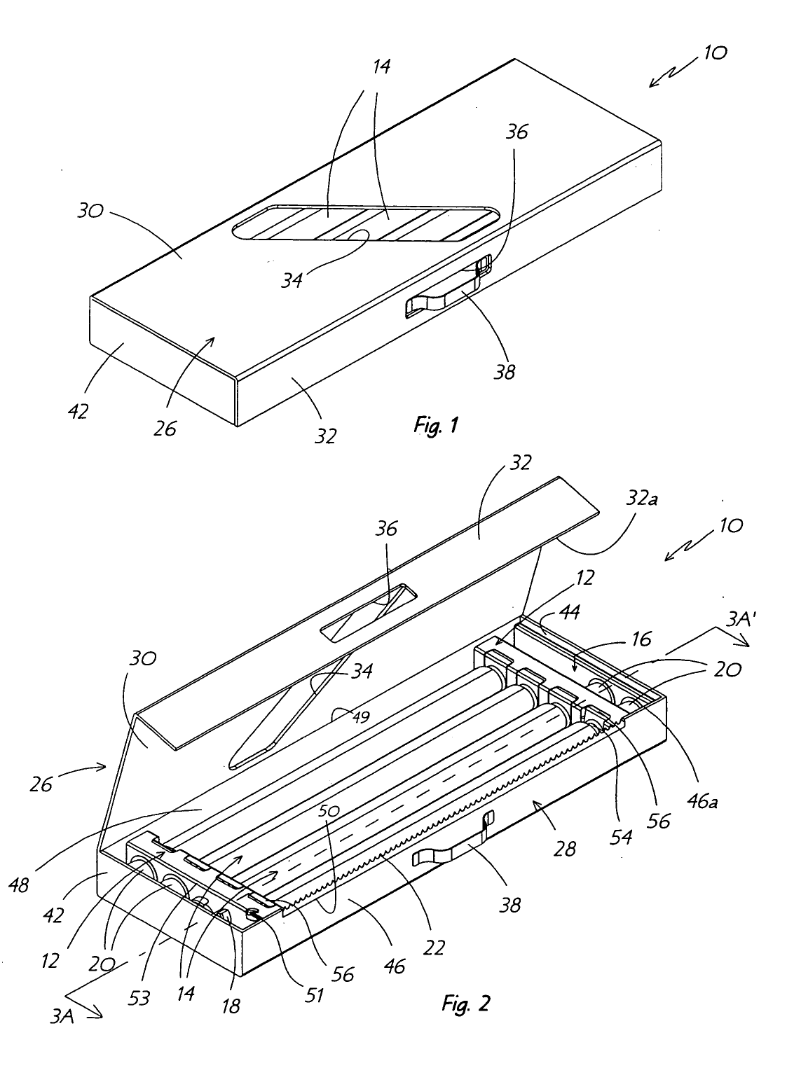

Referring to FIGS. 1-3A, there is shown a storage case, indicated generally at 10, in accordance with the present invention. Case 10 includes two spaced-apart roll retainers 12 that are adapted to rotatably support a plurality of hollow tubular rolls 14 holding sheet-like material, such as gift wrapping paper 24. Case 10 preferably also include compartments 16 that are adapted to hold rolls of adhesive tape 18, spools of ribbon 20 and other accessories for wrapping and decorating gifts such as gift cards and writing implements. Compartments 16 may be integrally formed with roll retainer 12 or may be a separate unit. Roll retainer 12 and other embodiments thereof will be described hereinafter. A cutter blade 22 preferably is provided along a front edge of case 10 so as to allow a user to cleanly cut through the paper 24 when a desired length of the same has been unwound from rolls 14.

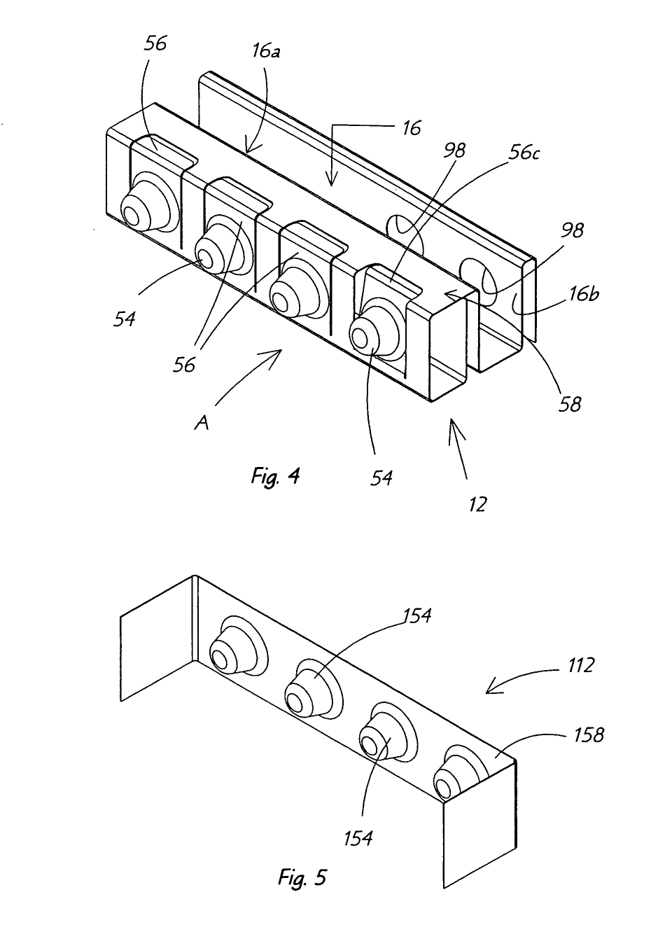

Continuing to refer to FIGS. 1-3A and to FIG. 4, storage case 10 may be manufactured from cardboard or wood, or may be molded from plastic or any other suitable material. Case 10 includes an upper section or lid 26 and a lower storage section 28. Lid 26 preferably has a planar top panel 30 and a downwardly extending closure panel 32. Top panel 30 may include an aperture 34 through which the paper 24 on rolls 14 may be viewed. Panel 32 preferably includes an aperture 36 which is sized to receive a handle 38 therethrough. Storage section 28 includes a bottom wall 40, side walls 42 and 44, a front wall 46 and a rear wall 48. Section 28 is therefore a substantially rectangular open-topped box having a length that is at least sufficient to accommodate the length of rolls 14. Additionally, the length of section 28 may include the width of roll retainers 12 and compartments 16. Section 28 is adapted to receive rolls 14 which are horizontally oriented and lie substantially parallel to the longitudinal axis XX′ of the bottom wall 40. Top panel 30 of lid 26 is hingedly connected to the rear wall 48 of section 28 by means of conventional hinges (not shown). Preferably, lid 26 and storage section 28 are integrally formed as a one-piece plastic member and top panel 30 is separated from rear wall 48 by a thinner area of plastic which forms a hinge 49 therebetween.

Front wall 46 of storage section 28 preferably includes a recess 50 into which cutter blade 22 is mounted. Recess 50 is of a length sufficient to accommodate the width of paper 24 carried on rolls 14. Cutter blade 22 preferably has a plurality of teeth or a sharpened edge 52 to cut through the paper 24. It will be understood by those skilled in the art that recess 50 does not need to be formed in front wall 46 and that blade 22 may be mounted on the top edge 46a (FIG. 2) of front wall 46 or on the lower edge 32a of panel 32 without departing from the spirit of the present invention.

When storage case 10 is closed (FIG. 1), panel 32 of lid 26 overlaps front wall 46 of section 28. Handle 38 preferably is mounted on front wall 46 of section 28 and is receivable through aperture 36 to keep case 10 substantially in the closed position. While a locking mechanism (not shown) may be provided, case 10 is easily held shut by handle 38 projecting through aperture 36 in lid 26. Alternatively, handle 38 may be mounted directly onto panel 32 and a lock (not shown) may be provided to secure upper and storage sections 26 and 28 together.

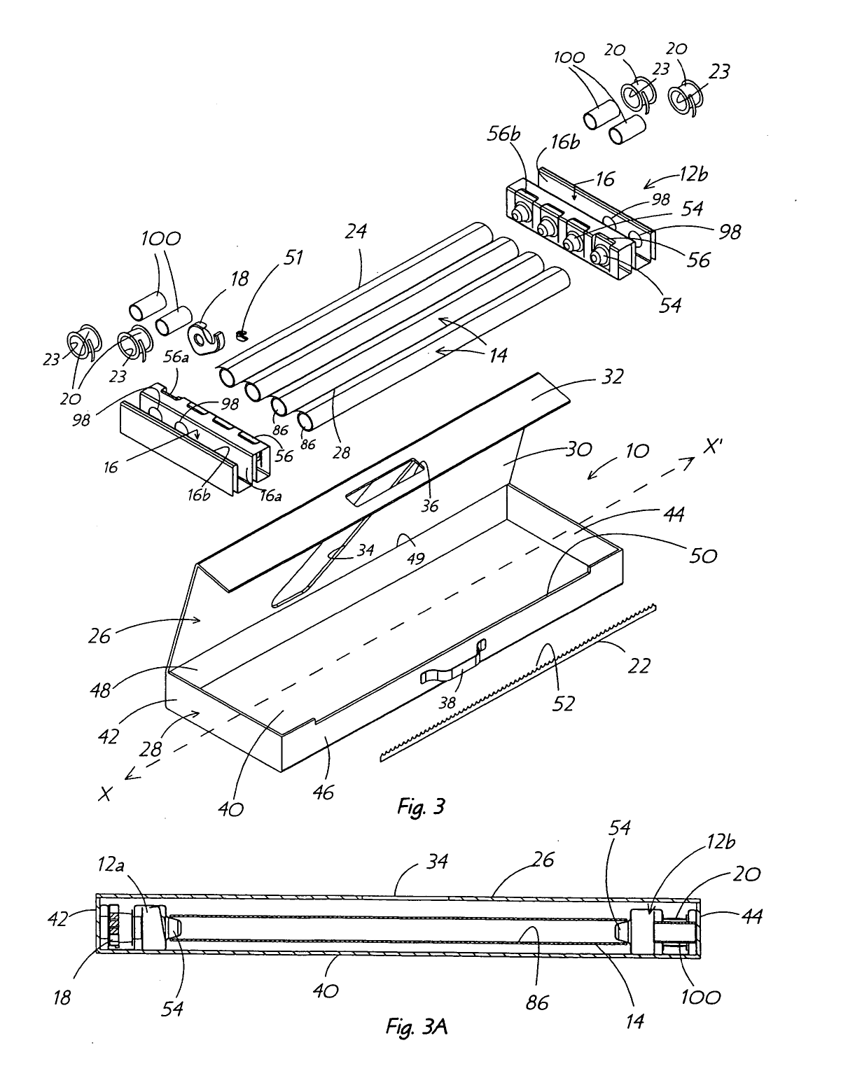

Case 10 and its component parts, such as roll retainers 12 and compartments 16, may be integrally manufactured from one material such as cardboard, wood or molded plastic. However, roll retainers 12 and/or compartments 16 may be separately formed and these separate components may be manufactured from a completely different material than case 10 and inserted into case 10 and secured into place by friction, adhesive, screws or any other devices. Furthermore, while compartments 16 are shown in FIGS. 2-3A as being disposed substantially perpendicularly to the longitudinal axis XX′ of section 28, they may alternatively be formed or inserted to lie substantially parallel to the longitudinal axis XX′ of section 28. It can be seen in FIGS. 2-4, that case includes at least one compartment 16 that is adapted to hold accessories such as spools of ribbon 20 and adhesive tape dispensers 18. In order to provide a mechanism for mounting spools of ribbon 20, walls 16a, 16b of compartment 16 includes opposed aligned apertures 98 that are adapted to receive shafts 100 therein. Shafts 100 are received through bores 23 of spools of ribbon 20 and are adapted to secure the spools of ribbon 20 within compartments 16. A cutter 51 (FIG. 3) preferably is provided on compartment 16 for cutting lengths of ribbon 20 or tape 18. Cutter 51 may be fixedly mounted on compartment 16 or may slide along a groove 53 to lay proximate the ribbon or tape.

Referring to FIGS. 2 through 9C, a variety of different embodiments of roll retainer 12 may be used to hold rolls 14 of paper 24 within case 10. FIGS. 3-4, show a first embodiment of roll retainer 12 that comprises a support bracket 58 having a plurality of hubs or nodes 54 mounted or formed on depressable tabs 56. One roll retainer 12a is disposed proximate side wall 42 and a second roll retainer 12b is disposed proximate side wall 44. The distance between roll retainers 12a and 12b is approximately equal to the length of a roll 14 of paper 24. When the two roll retainers 12a, 12b are so positioned, pairs of nodes 54 on the respective roll retainers are coaxially aligned with each other, such as is indicated by coaxially aligned tabs 56a, 56b. When a roll 14 is to be inserted between the nodes 54 of a coaxially aligned pair, at least one of the tabs 56 is depressed inwardly in the direction of arrow A, as is shown on tab 56c of FIG. 4. One end of a roll 14 is inserted over one of the nodes 54 of the pair so that node 54 enters a bore 86 of roll 14. The other end of roll 14 is brought into proximity of the second node of the pair. The depressed tab 56 is then allowed to spring back into its starting position and roll 14 is clamped between the two tabs. In this position, roll 14 is mounted for axial rotation between the two nodes 54 (FIG. 2).

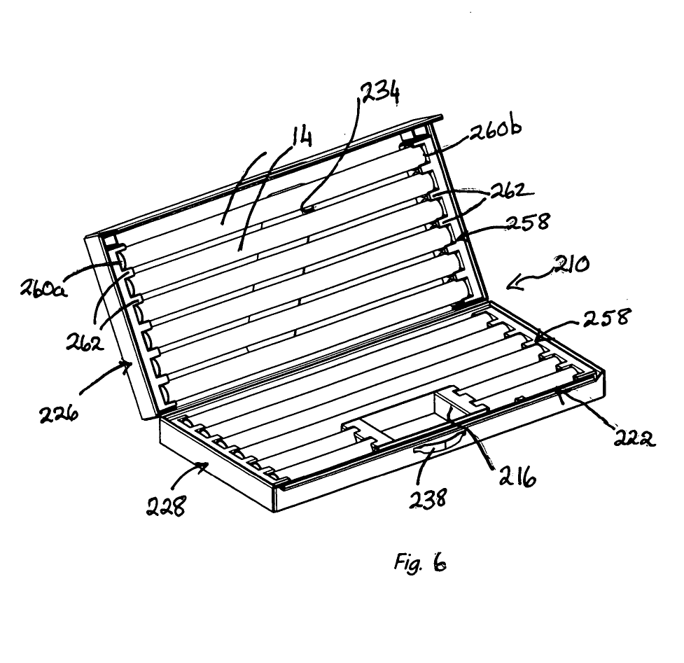

A second embodiment of roll retainer is shown in FIG. 5 and indicated at 112. In this embodiment, roll retainer 112 comprises a support bracket 158 that includes a plurality of nodes 154 fixedly mounted or formed on bracket 158. Roll retainers 112 may be positioned in abutting contact with side walls 42, 44 of a storage case 10 or in abutting contact with a separately formed compartment unit (not shown). A roll 14 of paper 24 is inserted onto coaxially aligned nodes 154 of opposing roll retainers 112 by causing the cardboard tube that typically forms roll 14 to deform slightly to fit into the gap between opposing nodes 154. Once the nodes 154 are engaged in bore 86 of roll 14, the cardboard tube can simply be straightened out again. Roll retainer 112 may alternatively be used in conjunction with roll retainer 12 as previously described. In that instance, tab 56 of roll retainer 12 is depressed in order to allow roll 14 to be inserted between roll retainer 12 and roll retainer 112.

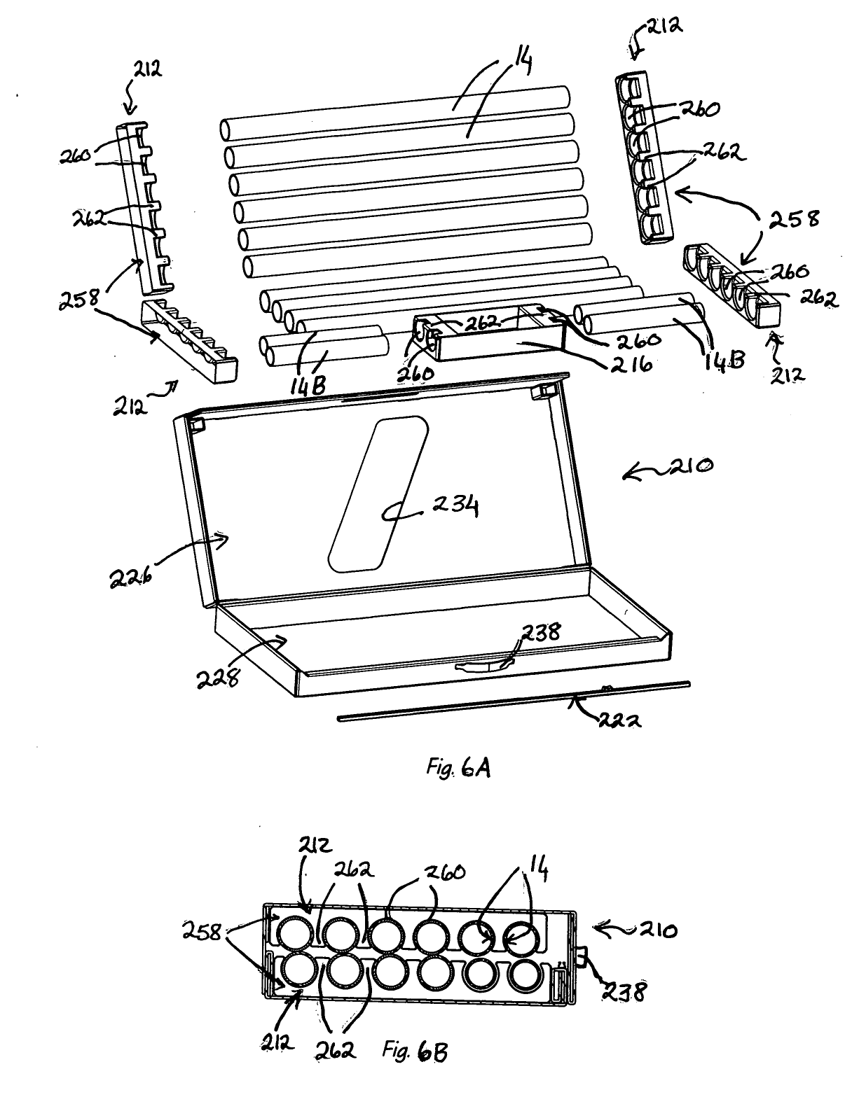

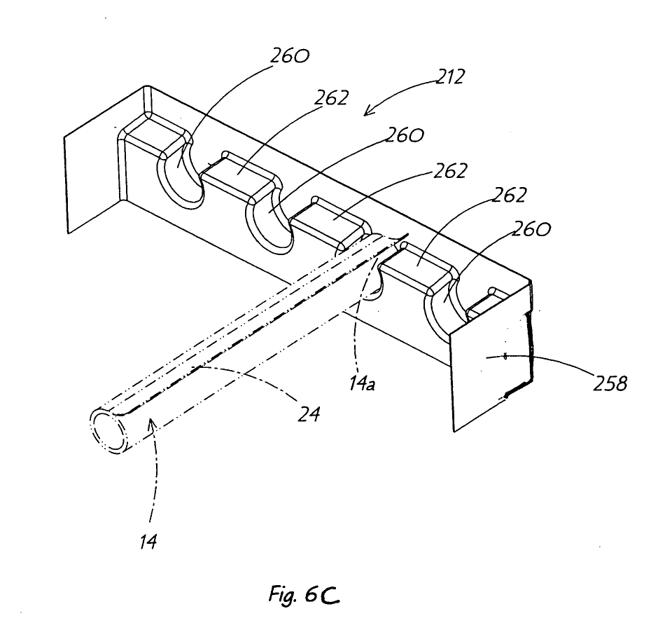

A storage case 210, including a third embodiment of a roll retainer 212 is illustrated in FIGS. 6-6C and generally indicated at 212. In roll retainer 212, support bracket 258 includes a plurality of spaced-apart grooves 260 separated from each other by ridges 262. Grooves 260 are arcuate in cross-section when viewed from the sides of storage case 10. Grooves 260 of the two spaced apart roll retainers 212 are aligned in coaxial pairs so that a single roll 14 of sheet material may be supported therebetween. Each groove 260 preferably has a curvature which is less than that of a complete circle, but greater than that of a semicircle. This degree of curvature is sufficient to provide a snap-fit type of interaction with ends 14a of a roll 14. The curvature of grooves 260 therefore hold the ends 14a of roll 14 sufficiently firmly so as to prevent roll 14 from being accidentally dislodged from groove 260 when paper 24 is removed from roll 14, but also sufficiently loosely to allow roll 14 to rotate therein. The outer edges of paper 24 on roll 14 are supported by ridges 262 when paper 24 pulled forwardly toward the cutter blade 222 as paper 24 is removed from roll 14. A single roll retainer 212 of the design shown in FIGS. 6-6C may be used in combination with either of the previously described roll retainers 12 and 112. It should be understood that the grooves 260 of the spaced apart roll retainers 212 are aligned in coaxial pairs such as 260a and 260b (FIG. 6) and that the grooves of at least one of the coaxial pairs can have a first diameter and the grooves of one other of the coaxial pairs can have a second diameter (not shown), with the first and second diameters being different. This enables differently sized rolls 14 of sheet material to be held in the differently diametered roll retainers 212. It should also be noted from FIGS. 6-6C that both the lid 226 and storage section 228 of case 210 preferably are rectangular open-topped boxes which each include roll retainers 212 for holding a plurality of rolls of sheet material therein. Furthermore storage case 210 also includes an accessory compartment 216 for holding ribbon, adhesive tape, gift cards, writing implements etc. Compartment 216 may also be provided with a plurality of alternating grooves 260 and ridges 262 so that smaller rolls 14B of sheet material can be secured between compartment 216 and supports 258. As with previous embodiments, case 210 may be provided with an aperture 234 through which the rolls 14 and 14B can be partially viewed, and with a second aperture (not shown) through which handle 238 can be received for securing lid 226 and section 228 together.

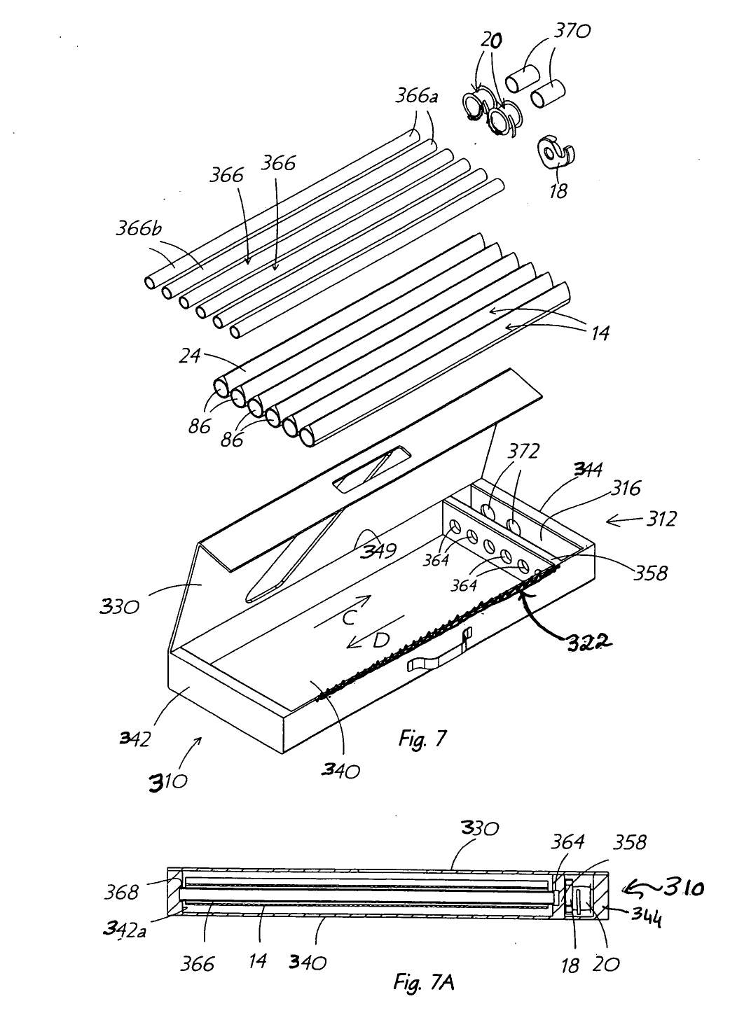

A fourth embodiment of a roll retainer is illustrated in FIGS. 7 and 7A and indicated generally at 312. In this embodiment, roll retainer 312 may be provided proximate one end of case 10 and the other side wall 342 may be provided with a plurality of spaced apart holes 368 (FIG. 7A) which are coaxially aligned with holes 364 in support 358. Supporting rods 366 extend through bores 86 of rolls 14 and are inserted into aligned holes 364 and 368 and rotatably mount rolls 14 thereon. Alternatively, it will be understood that identical roll retainers 312 may be provided at both ends of case 310 and be positioned so that pairs of coaxially aligned holes 364 are provided for receipt of rolls 14. In order to insert a rod 366 and roll 14 into the aligned pair of holes 364 and 368, a first end 366a of rod 14 is inserted into a hole 364 in support bracket 358 and pushed sufficiently therein, in the direction of arrow C (FIG. 7) to allow the second end 366b to clear inner surface 342a (FIG. 7A) of side wall 342. The second end 366b of rod 366 is then brought into the proximity of hole 368 and rod 366 is moved in the direction of arrow D. This allows second end 366b to be inserted into the hole 368. As can be seen from FIG. 7A, rod 366 is slightly longer than roll 14 so that roll 14 can rotate freely as paper 24 is unwound therefrom. Support bracket 358 may also include a compartment 316 for holding ribbon spools 20 and adhesive tape dispenser 18. Shafts 370 are insertable through the bore of spools of ribbon 20 and through coaxially aligned holes 364 and 372 enabling ribbon to be dispensed therefrom. A cutter blade 322 is provided to cut paper 24 and ribbon therefrom.

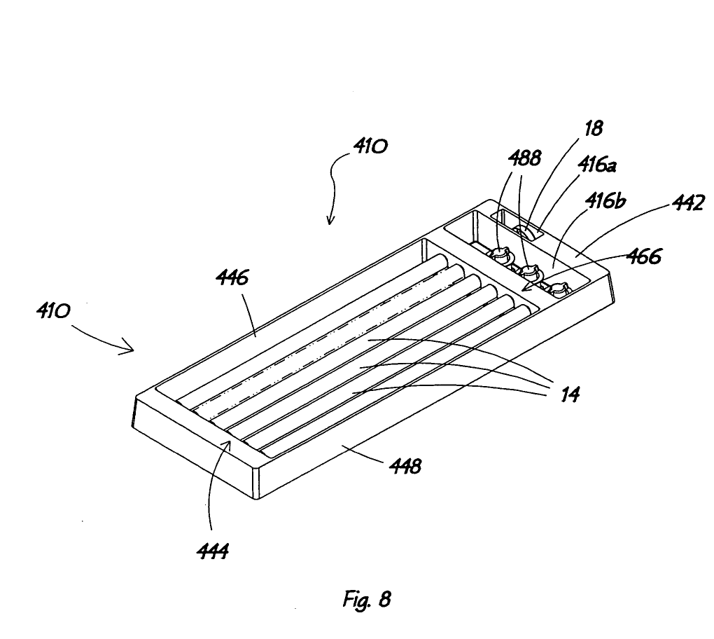

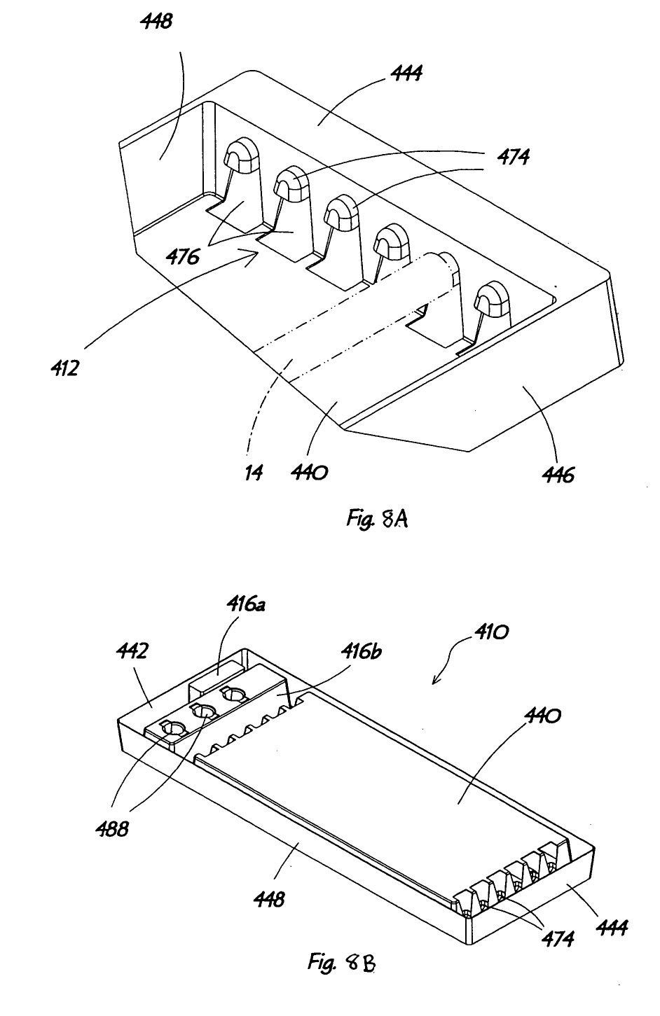

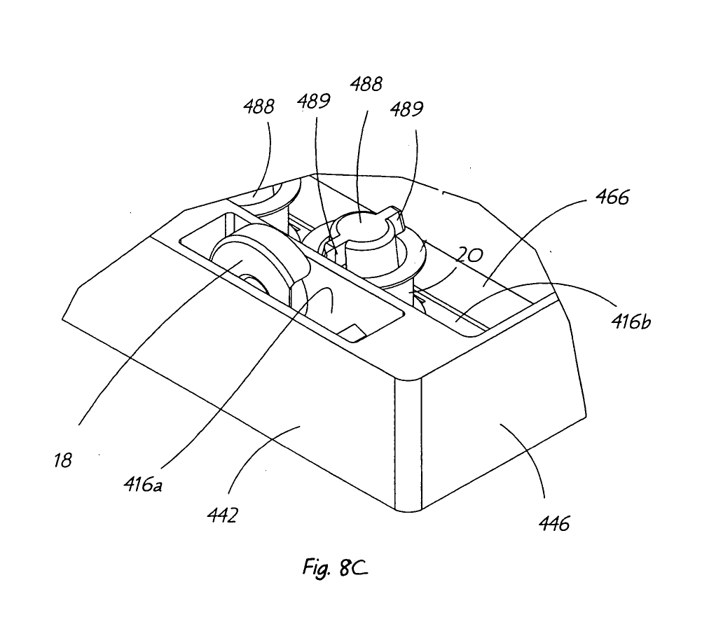

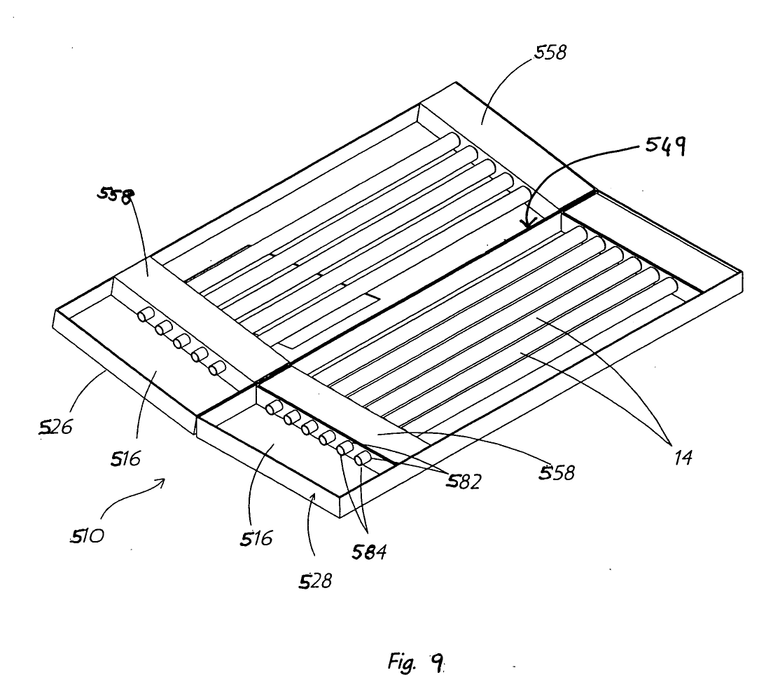

A fifth embodiment of a roll retainer is illustrated in FIGS. 8-8C and indicated generally at 412. This storage case 410 preferably is molded from a material such as plastic with the front and rear walls 446, 448, bottom wall 440 and side walls 442, 444 are integrally formed. Roll retainer 412 includes a support bracket, namely side wall 444 and retainer wall 466 (FIG. 8), that each have a plurality of spaced-apart detents 474 mounted or formed thereon. Detents 474 on opposing walls 444, 466 are coaxially aligned in pairs. Detents 474 preferably have a semicircular or circular perimeter so that the ends of a roll 14 may be rotatably held thereon. The support or side walls 444, 446 may include cut-away sections 476 associated with each detent 474 to allow for easier rotation of a roll 14 thereon. In order to insert a roll 14 between pairs of coaxially aligned detents 474, the cardboard inner tube of roll 14 is slightly deformed as previously described, so that detents 474 engage in the bore 86 of roll 14. Once the roll 14 is engaged on detents 474, the cardboard tube is manipulated so that the deformity is substantially reversed. Roll 14 is then free to rotate and to dispense paper therefrom. Compartments 416a, 416b may be molded as part of storage case 410 and are provided for holding rolls of adhesive tape 18 and spools of ribbon 20. Spools of ribbon 20 may be inserted over upstanding support posts 488 which include outwardly flaring guides 489. Guides 489 have sufficient flexibility to allow spool 21 to be pushed over them and onto post 488, but prevent it from being accidentally removed therefrom. Additionally, it should be understood that while a conventional adhesive tape dispenser 18 is shown in the attached drawings, the roll of tape may be removed from the dispenser 18 and be mounted into the storage case in a manner similar to that described with reference to the spools of ribbon 20. The ribbon and tape may be cut using a cutter blade (not shown) attached to storage case 410, or may be cut using other conventional means such as scissors.

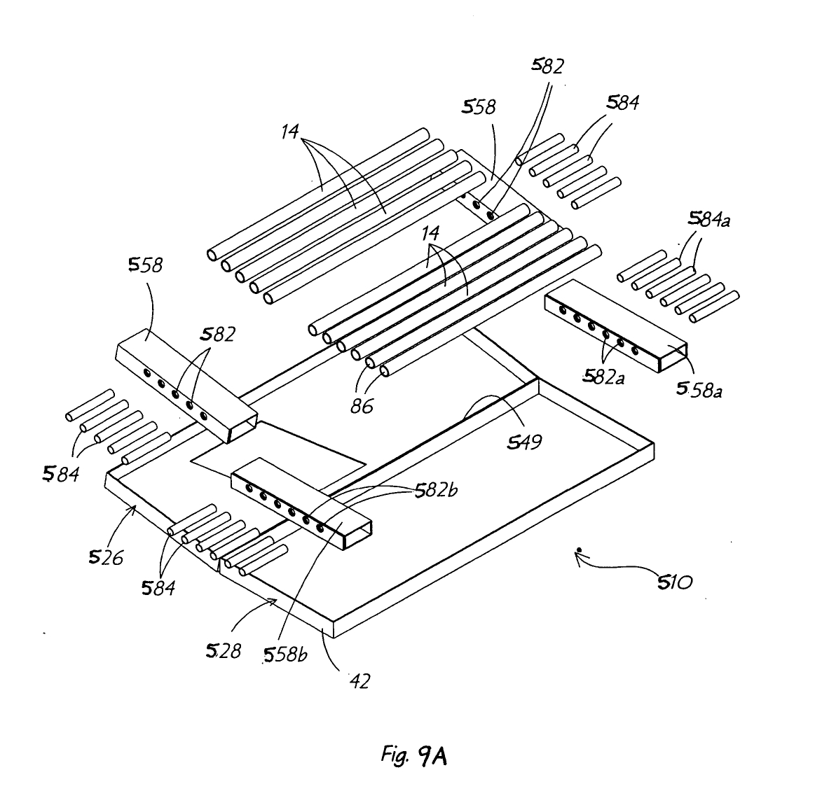

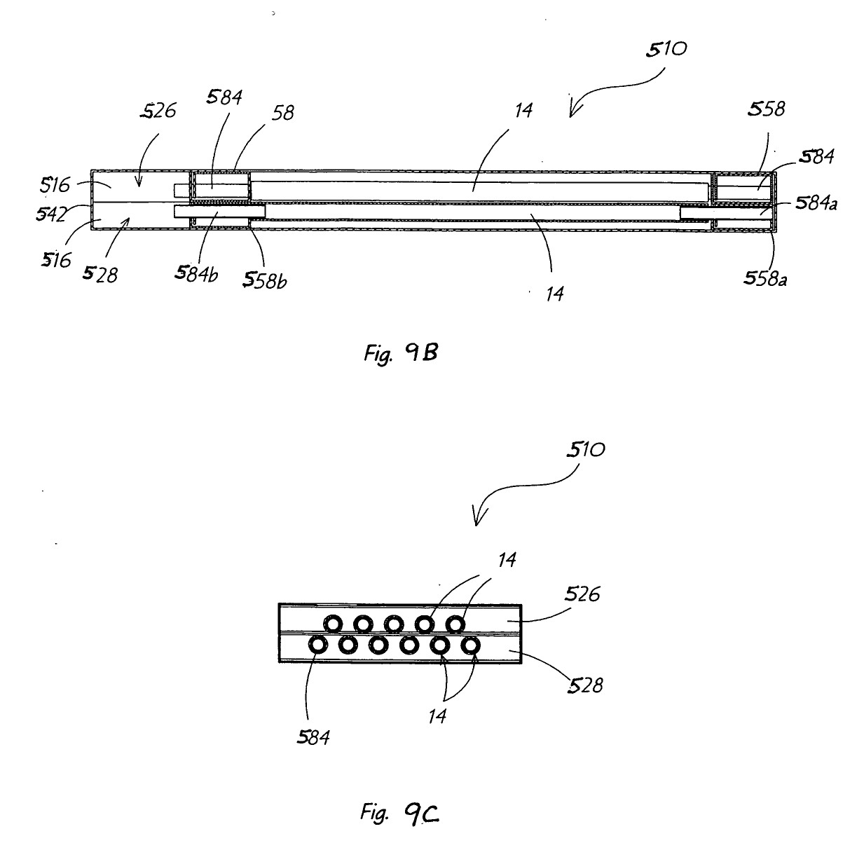

FIGS. 9 through 9C show a storage case 510, which again has both upper and lower storage sections 26, 28 shaped as open-topped rectangular boxes for storing and dispensing sheet materials, such as gift wrapping paper 24. Upper and storage sections preferably are open-topped rectangular boxes that are hinged together by hinge 549. Case 510 is adapted to store rolls 14 in both upper section 526 and lower section 528 in the manner previously described with reference to section 28 of case 10. A sixth embodiment of a roll retainer is illustrated in FIGS. 9-9C and generally indicated at 512. In this embodiment, each support bracket 558 includes a plurality of spaced apart holes 582. A plurality of dowels 584 are inserted through holes 582 and engage in bores 86 of rolls 14. Rolls 14 are placed into case 510 by inserting dowels 584a (FIG. 9A) into holes 582a in support bracket 558a. Rolls 14 are then positioned between the two coaxially aligned support brackets 558a and 558b (and dowels 584b are inserted through holes 582b and into bores 86 of rolls 14). Dowels 584b extend partially into compartment 516 formed between bracket 558b and side wall 542 so that they may easily be grasped for removal from a roll 14 which no longer has any paper 24. As is shown in FIGS. 9B and 9C, when case 510 is closed and the upper and storage sections 526, 528 are disposed one on top of the other, rolls 14 are staggered with respect to each other so that they do not interfere with each other.

It will be understood by those skilled in the art that any combination of previously described roll retainers 12, 112, 212, 312, 412 and 512 may be used in a storage case 10 through 510 in accordance with the present invention. It is also to be understood by those skilled in the art, that the roll retainers, if separately manufactured, may be movable relative to each other so that a different length of roll 14 can be held between cooperating pairs of roll retainers. It should also be understood that a storage case may require only one roll retainer if the opposite side wall of the storage case includes some type of axially aligned mechanism to cooperate with the roll supporting mechanism provided on any of the previously described roll retainers. The retainers as described herein are by way of example only and the retainers are not limited to these specific descriptions but may include any other suitable mechanisms for rotatably locking a roll 14 into a section of storage case.

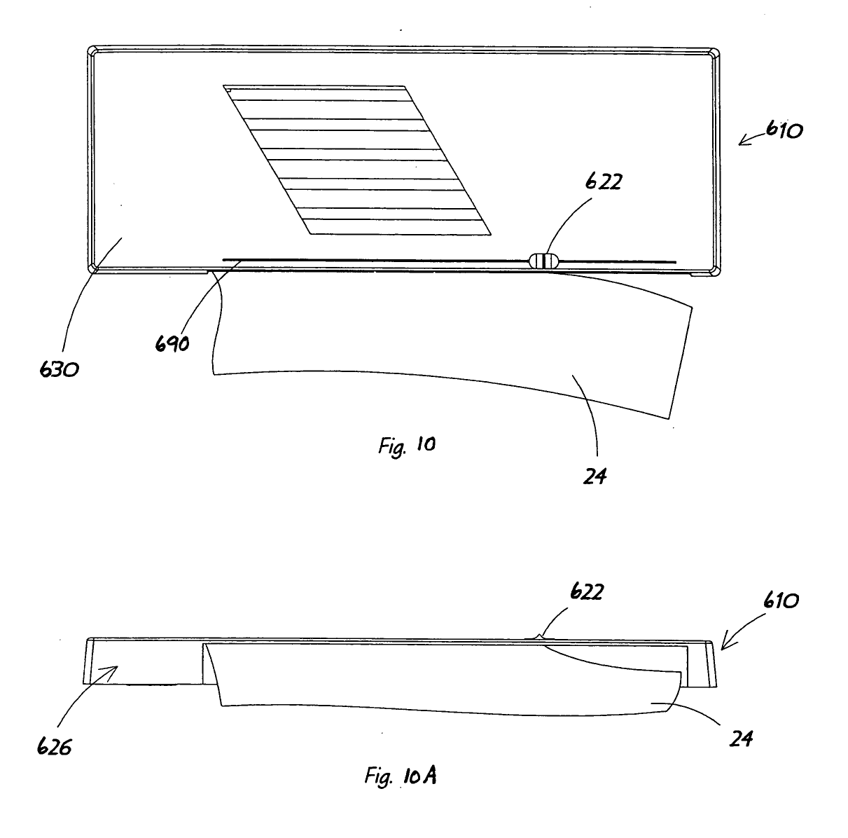

Furthermore, as is shown in FIGS. 10 and 10A, a slot 690 may be provided in the top panel 630 of upper section 626 of storage case 610. A cooperating cutter blade 622 may be slidably mounted within slot 690 and blade 622 is drawn across the paper 24 to cut a section of paper from the roll mounted within the storage case 610.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A sheet material storage case comprising:
a housing having an upper section and a lower section and having a longitudinal axis;
a pair of spaced apart roll retainers disposed within the housing;
a plurality of roll engaging mechanisms disposed in each roll retainer, the roll engaging mechanisms being adapted to secure a plurality of rolls of sheet material therein substantially parallel to the longitudinal axis of the housing; the roll engaging mechanisms being adapted hold the rolls sufficiently firm to prevent accidental dislodgement but sufficiently loosely to allow for rotation of the roll as sheet material is withdrawn therefrom.

2. The storage case as defined in claim 1, further including a cutter blade disposed on one of the upper and lower sections and being adapted to cut sections of sheet material from rolls secured within the cavity of the case.

3. The storage case as defined in claim 2, further comprising a track disposed on one of the upper and lower sections and wherein the cutter blade is slidable along the track to cut sections of sheet material from the rolls.

4. The storage case as defined in claim 3, wherein the roll engaging mechanisms comprise a plurality of alternating grooves and ridges formed in the roll retainer, and wherein the grooves are adapted to snap-fittingly receive an end of a roll therein.

5. The storage case as defined in claim 4, wherein the grooves are arcuate in cross-section.

6. The storage case as defined in claim 5, wherein the grooves of the spaced apart roll retainers are aligned in coaxial pairs and each of the coaxial pairs of grooves have the same diameter.

7. The storage case as defined in claim 5, wherein the grooves of the spaced apart roll retainers are aligned in coaxial pairs and the grooves of at least one of the coaxial pairs have a first diameter and the grooves of at least one other of the coaxial pairs have a second diameter, and the first and second diameters differ.

8. The storage case as defined in claim 1, wherein the roll engaging mechanisms are arranged in coaxially aligned spaced apart pairs and each pair of roll engaging mechanisms is adapted to secure a roll of sheet material between them.

9. The storage case as defined in claim 8, wherein the roll retainers include a support bracket and the roll engaging mechanisms comprise a plurality of spaced apart hubs that project outwardly from the support bracket.

10. The storage case as defined in claim 9, wherein the support brackets include a plurality of depressable tabs and the hubs are mounted on the tabs.

11. The storage case as defined in claim 8, wherein the roll retainers include a support bracket and the roll engaging mechanisms comprise a plurality of spaced apart apertures in the support bracket and wherein the apertures are adapted to receive an end of a roll therein.

12. The storage case as defined in claim 11, wherein the roll engaging mechanisms further include dowels that are adapted to be inserted through the bores of the rolls and through the apertures in the support bracket.

13. The storage case as defined in claim 1, further comprising at least one compartment disposed within the interior of the housing, the compartment adapted to receive wrapping accessories therein.

14. The storage case as defined in claim 1, wherein the compartment is fixedly secured within one of the upper and lower sections of the storage case.

15. The storage case as defined in claim 1, wherein the compartment is selectively removable from within one of the upper and lower sections of the storage case.

16. The storage case as defined in claim 13, wherein the compartment extends upwardly from a bottom wall of one of the upper and lower sections of the housing.

17. The storage case as defined in claim 16, wherein the compartment is integrally formed with one of the roll retainers.

18. The storage case as defined in claim 16, wherein the compartment includes roll engaging mechanisms which are adapted to secure a plurality of rolls of sheet material therein.

19. The storage case as defined in claim 16, wherein the compartment includes at least one accessory restraining device adapted to hold an accessory sufficiently firmly to prevent the accessory from being accidentally dislodged from the compartment.

20. The storage case as defined in claim 19, wherein the compartment includes opposed walls and the accessory restraining device comprises at least one pair of coaxially aligned holes formed in the opposing walls and a shaft, and wherein the shaft is adapted to be inserted through a bore of a wrapping accessory and received into the pair of coaxially aligned holes.

21. The storage case as defined in claim 16, wherein the compartment further includes a cutter adapted to be used to cut sections of ribbon and tape stored in the compartment.

22. The storage case as defined in claim 1, wherein the roll retainers are movable toward or away from each other along the longitudinal axis of the housing.

23. The storage case as defined in claim 1, wherein the roll retainers are selectively removable from the housing.

24. The storage case as defined in claim 1, wherein the roll retainers are integrally formed with the housing.

25. The storage case as defined in claim 1, wherein both the upper section and lower section of the housing include a pair of roll retainers and a plurality of roll engaging mechanisms whereby both the upper and lower sections of the housing are adapted to store a plurality of rolls of sheet material therein.

26. The storage case as defined in claim 1, wherein the roll retainers are disposed at substantially ninety degrees to the longitudinal axis of the housing.

27. The storage case as defined in claim 3, wherein the roll engaging mechanisms include a plurality of rods and a plurality of spaced apart apertures formed in coaxially aligned pairs in the roll retainers, the rods being insertable into the pairs of apertures and being adapted to be inserted through the bores of rolls of sheet material, whereby the rolls of sheet material are rotatably secured between the roll retainers.

28. The storage case as defined in claim 1, wherein the upper and lower sections are hingedly secured together to form closeable unit that has an interior cavity.

29. The storage case as defined in claim 28, further comprising a handle disposed on one of the upper and lower sections of the housing and an aperture formed in the other of the upper and lower sections of the housing, said aperture being shaped and sized to receive the handle therethrough, whereby the storage case is held closed when the handle is received through the aperture.
